(19) United States
(12) Patent Application Publication
(10) Pub. No.: US 2005/0046197 A1
(43) Pub. Date: Mar. 3, 2005

(54) Wind energy production using kites and ground mounted power generators

(76) Inventor: Gordon Bruce Kingsley, Granite Bay, CA (US)

Correspondence Address: GBK ASSOCIATES;GORDON B. KINGSLEY, 8885 LOS LAGOS CIR S, GRANITE BAY, CA, 95746, US

(21) Appl. No.: 10/656,004

(22) Filed: Sep. 3, 2003

(51) Int. Cl. F03D 9/00; H02P 9/04

(52) U.S. Cl. 290/55

(57) ABSTRACT

Systems and methods are described for creating low cost energy using kites connected to ground mounted equipment. In power mode the kites generate maximum energy by positioning the kite at a high angle of attack relative to wind direction. The kite is allowed to travel a distance limited only by the length of line attached. The opposite end of the line is attached to a reel capable of turning a shaft to create mechanical or electrical energy. Upon reaching a controlled length, the kite is repositioned to a minimum angle of attack relative to the wind to minimize energy required to retrieve the kite. The shaft rotation is then reversed thereby winding the line on the reel. Energy is expended in retrieval mode. The difference in energy during power and retrieval mode is the net energy gain available for useful work.

### CROSS REFERENCE TO RELATED PATENTS

To be determined.

### STATEMENT REGARDING FEDERALLY SPONSORED R&D

Federal funds were not used for research and development of this patent.

### REFERENCE TO SEQUENCE LISTING

Not applicable.

### BACKGROUND OF THE INVENTION

Currently windmills dominate the wind generation power industry. Typically a propeller is directly connected to a generator. Wind causes the propeller to spin thereby turning the generator and producing electrical energy. Also windmills are used to drive pumps and other mechanical devices such as a pump. A propeller is directly connected to a mechanical shaft that is linked to the pump. The configuration and size of windmills varies. The windmill was first invented in 600 A.D. in Persia (Information Please Almanac, 1994 p 555). Old Dutch style windmills dating back hundreds of years are still in use in farm communities. New high tech windmills with massive blades soaring a hundred feet in the air are in use in wind farms throughout the world. Based on a recent article the trend is toward larger windmills (Barry Newman, “Honest: Mr. Mueller Actually Does Tilt At Actual Windmills” Wall Street Journal, page A1, Nov. 19, 2000). Unfortunately the larger windmills the more likely they are to kill birds, and often produce noise and be aesthetically unsightly.

Propeller type windmills also are low in energy efficiency. The small profile and drag of the propeller blade severely limits the energy that is transmitted to the shaft. During low velocity or rapidly changing wind directions, windmills propellers are either not turning or at an angle relative to wind direction that little or no energy is generated. Maintenance is a compounding problem. Often larger blades generate vibration and premature failure. All these factors in combination lower the potential for windmills to compete with other means for generating power.

Harnessing the energy of the wind by means of a kite is nothing new. Numerous inventions related to kites and energy exist, yet none have provided a practical means of generating power. Recent patents describe windmills and generators mounted within kites and elevated to great heights. Power is relayed to a ground mounted power grid for collection and distribution. All though these patents have been in existence for some time No practical means of controlling power generation are provided.

This invention is unique in the concept of controlling the flight of a kite to allow a ground mounted generator to produce electrical or mechanical power. Although kites may have been in existence for 2000 years (A. Loyd, Kites and Kite Flying, p 8, 1978) none produce significant power to this day. With the invention of rip-stop nylon and ultra strong lightweight high strength cables and struts, synchronous electrical generators, and sophisticated radio controls a system comprising these parts now make harnessing energy using kites cost effective.

This invention relates to a kite designed to transmit mechanical energy to a ground mounted, stationary generator where it generates electricity or direct energy to mechanical equipment such as pumps. This invention is designed to overcome problems with conventional windmills. The invention is environmentally friendly to birds and animals, optimizes energy production, is quiet, and pleasing to the eye.

In ‘power mode’ the widest section (foot print) of the kite is positioned at a high angle of attack to wind direction. A force is generated on the body of the kite, and transmitted to a spool connected to a generator shaft through a cable. As the wind pushes the kite, energy is generated in accordance with the laws of physics i.e. the force of the wind times the distance the kite traverses times a factor (to account for losses due to drag or orientation of the kite relative to wind direction). The cable unwinds turning the shaft of the generator. As it reaches the end of the cable the kite is repositioned to offer least resistance or low angle of attack to the wind direction referred to herein as ‘retrieval mode’. The generator reverses itself becoming a motor. The cable is wound onto the spool until reaching a preset distance at which time the entire cycle is repeated. The kite is designed to allow positioning relative to wind direction. A multitude of kite designs can be used. One kite configuration is illustrated to describe concept.

A second design kite utilizes air thermals or uplifts to generate power. The kite is in the shape of a parachute and is very lightweight. Air thermals rising from the earth's surface cause the kite to rise like a hot air balloon. Upon nearing the end of the cable the RMG reverses itself. The cable pulls on the center of the kite causing it to implode, thereby reducing wind resistance and pulling it towards the ground. At a preset distance from the ground the generator is stopped allowing the parachute to open and the cycle is repeated. Likewise uplifts or naturally occurring wind rising near mountains or cliffs, can be similarly utilized to generate power. Additional controls however, may be required to stabilize the direction of the kites relative to the wind.

Both designs provide a net gain of energy. The net gain is equal to the difference in energy generated during the ‘power mode’ less the energy required during the ‘retrieval mode.’

A further benefit of the kites is they can provide a media for advertising.

### BRIEF DESCRIPTION OF THE INVENTION

The field of endeavor to which the invention pertains is sustainable energy related to wind.

Various documents and references are listed below as general information related to development of the patent:
A-Phase II-Low Wind Speed Technology Development, DOE solicitation notice FBO #329, 27 October 2002.
Pols tilt at Windmills: Nantucket Sound Wind Power Proposal Under Fire, Boston Herald.com, Sep. 5, 2002
Second Wind for Wind Power, Wall Street Journal, 2002.
Honest Mr. Mueller, Actually Does Tilt at Actual Windmills, Nov. 20, 2002.
Wind: Emphasis on Tying Work to Specific Needs, Sacramento Bee, Apr. 1, 2002.
U.S. Aims to Have 5 Percent of Power from Wind by 2020, M. L. Wald, NY Times, Jun. 20, 1999.
   Patents:
20030091437 Windmill kite
20020040948 Axial-mode linear wind-trubine
20020192068 Serpentine wind turbine
20030154898 Bridle for power kite launching
20030150957 Adaptable kite/airfoil
20030140835 Wind-propelled watercraft
20030132348 Ram air inflated wing
20030121462 Sailing craft
20030116071 Control device for kite

The object of the invention is to generate sustainable energy from wind in an environmentally friendly, energy efficient, aesthetically pleasing and cost effective means compared to turbine and other forms of wind power generating devices. A brief comparison follows:

| Description | Kite Powered Generator | Wind Turbine |
|---|---|---|
| Efficiency | High efficient large cross | Limited efficiency, |
| | sectional area results in | Propeller cross section and |
| | high energy generation; | size limited by mechanical |
| | Kites can fly at high ele- | strength of materials; |
| | vations where 20% to 50% | Ground mounted is only |
| | higher wind velocity/energy | practical application to |
| | is available | date, lower wind velocity |
| | | translates to less efficiency. |
| Environmental | No environmental issues; | Numerous bird kills |
| | No bird kills | including endangered |
| | | species |
| Aesthetics | Requires small footprint; | Requires large number over |
| | kites can be designed to fly | considerable artea; not |
| | high; materials can be | pleasing to view; noise is |
| | transparent to naked eye; | high pitch low frequency |
| | noise is very low-no high | causing community |
| | pitched low frequency noise | concerns. |
| | generated. | |
| Costs | Low cost due to lower | High cost for capital, |
| | capital, operating and | operating and maintenance. |
| | maintenance. | |

GBK Associates has traveled to Palm Springs, Calif., Cape Cod, Livermore (Altamont Pass), CA, Cabos San Lucas, Mexico and other areas and conducted research using various kite forms to determine the potential for kite generated power.

While in these areas community leaders were contacted and interviewed. Based on this work GBK Associates believes there is a high market demand for this invention throughout the World.

### BRIEF DESCRIPTION OF THE SEVERAL VIEWS OF THE DRAWINGS

FIG. 1 is a top plan view of an assembled kite and cable constructed is accordance with the invention,

FIG. 2 is an edge or elevation view of the assembled kite and cable,

FIG. 3 is an isometric, (three dimensional) view of the combination generator/reversible electric motor,

FIG. 4 is an elevation view of a parachute alternative design in power mode,

FIG. 5 is an elevation view of a parachute alternative design in retrieval mode,

FIG. 6 is an isometric, of a parafoil kite with line for power mode (flying line) and retrieval mode (retrieval line),

FIG. 7 is an isometric, of a sled kite with flying and retrieval lines,

FIG. 8 is an isometric, of a delta kite with flying and retrieval lines.

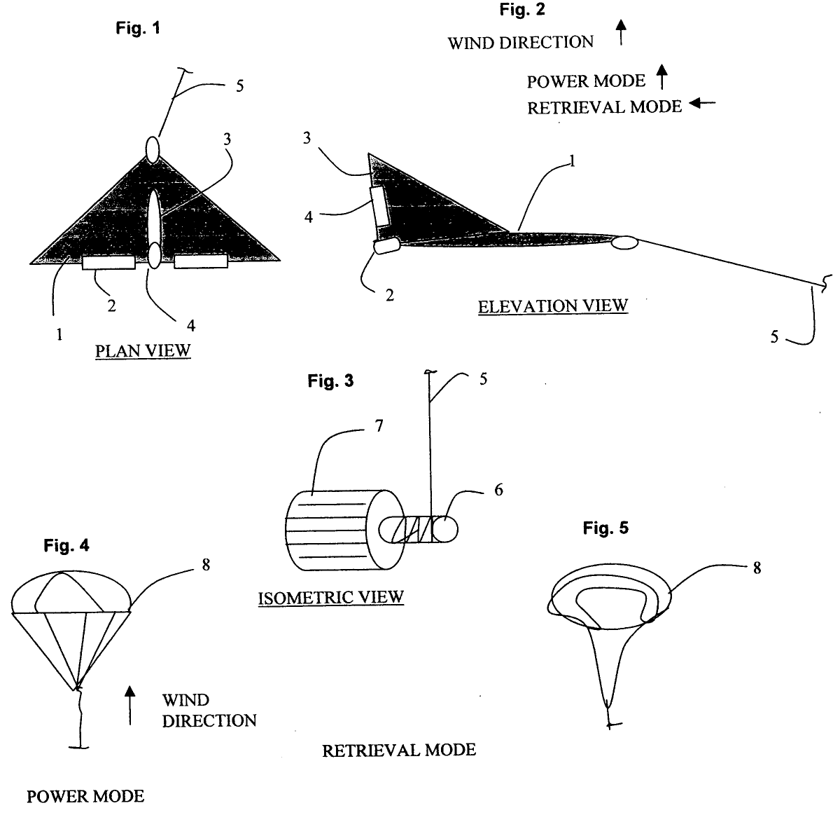

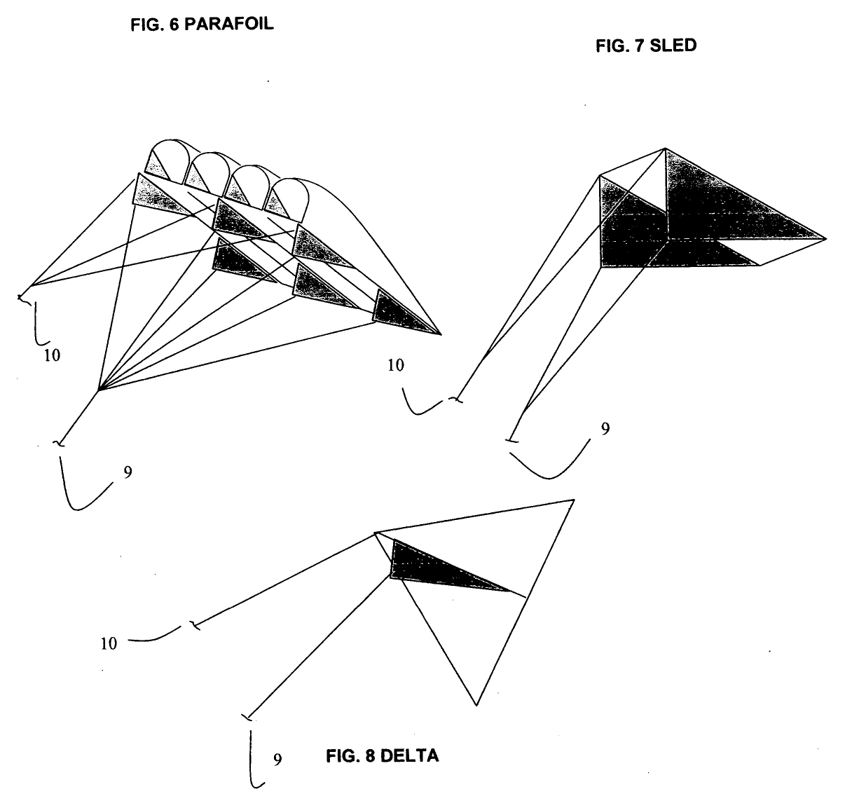

It is to be understood that the invention is not limited to the precise construction shown, but that changes are contemplated as readily fall within the spirit of the invention.

### DETAILED DESCRIPTION OF THE INVENTION

A kite 1 with radio controlled ailerons 2 and tail 3 with rudder 4 is attached to cable 5 that extends to the ground where it winds around a kite spool 6 connected to a reversible electrical motor/generator (RMG) 7. In power mode the kite is positioned perpendicular to wind direction by radio controlling the position of the aileron and rudder. The wind pushes the kite along its path causing the cable to unwind from the motor spool 6 turning the generator and thereby producing electricity. As the cable unwinds, nearing its full length, an electrical relay stops the RMG 7 momentarily. The kite position is adjusted to retrieval position thus allowing the kite to slice through the air with minimum wind resistance as the RMG 7 reverses direction, winding the cable around the spool. As the cable reaches a second relay near the start of the cable (a safe distance above ground) the RMG is again stopped, rotation reversed and the cycle is repeated.

A second design is a parachute shaped kite 8 attached to a cable 5 and to a RMG as described above. The body is constructed of a lightweight material such as nylon. Initially, a propane heater warms air beneath the kite causing it to rise. Once airborne, hot air thermals provide energy needed to continue to lift the kite. Upon nearing the full length of the cable, the RMG stops momentarily and reverses itself. The middle of the kite is pulled down by the cable thereby minimizing wind resistance. The kite dives as the cable is rewound on the motor spool 6. Upon reaching a set altitude the RMG 7 again stops momentarily allowing the parachute kite to open. The kite catches wind from a rising thermal and the cycle repeats itself.

A third design is a set of two cables; one for power mode 9 and a second for retrieval mode 10. A separate RMG is provided at ground level for each cable that are sequenced to allow unraveling and rewinding of the cables during power and retrieval modes. Three separate kite designs—parafoil, sled, and delta—are shown.

UNIQUE ATTRIBUTES: The power generation potential of kites is only limited by the weather. Many areas of the world have suitable winds for practical use of kites to generate power. Wind farms now currently using wind mills will be better served by kites. The largest kite ever built was the Budweiser parafoil which measured 115′×124′ or 14,260 square feet (A. Loyd, Kites and Kite Flying, p 8, 1978). During its maiden flight it dragged two fully loaded dumpsters filled with sand before snapping a 25,000 lb 2″ thick nylon flying line under the intense pressure. People reported hearing what sounded like the loudest lightning they had ever heard! Obviously this only represents a minute fraction of the potential energy available to kites in combination with ground mounted generators. No rotating parts are elevated making maintenance convenient and inexpensive. There are no impellers that are subject to vibration and flexure and eventual failure. In addition, whereas conventional windmills kill birds and other wildlife, there is no recorded incident in which birds have been killed or injured despite millions of kites being flown each year.

Other Possible Uses and Variations:

Other possible uses are direct driven mechanical equipment such as pumps, conveyors or line shafts connecting multiple pieces of machinery, and fly wheels. Windmills have been used for centuries to pump water from wells to the surface. Kites with their greater energy potential could move massive amounts of water into reservoirs and later used to generate electricity using hydroelectric generators especially during peak demand. Like wise, banks of flywheels could be constructed that would store energy. In addition line shafts may become again useful. Line shafts were commonly used before the turn of the century to power entire industrial plants. Often plants were cited near rivers and streams in which a water wheel provided power to the line shafts. The invention of electrical motors greatly diminished the demand for line shafts. Concerns for the environment were minimal, coal, oil and natural gas were cheap and, as a result, electrical power plants sprung up around the world. Reverting back to line shafts where practical, would be efficient and environmentally friendly.

A variation is a kite design similar to conventional aircraft. The ailerons and tail rudder would be radio controlled (RC) to position the kite during power and retrieval modes. A single cable would connect the RMG to the kite simplifying design. Electrical power to actuate the ailerons and tail rudder would be supplied through rechargeable batteries installed on the kite, similar to a RC model airplane.

A second variation is a kite with two cables. The first is connected between the nose of the kite and a small RMG. The second is connected between the main body of the kite such as a parasail and a second RMG. Two separate RMGs may provide economy of design and simplify control depending on site conditions.

Kite forms, designs, materials of construction will vary depending on site conditions. Eight generic kite configurations are flat, bowed eddy, box, compound, sled, parafoil, delta, and rotor. Any or all designs may be utilized in this concept along with a host of aircraft designs configurations such as a flying wing. Kite body materials include ripstop nylon, reinforced polyethylene, silk, and other durable, high strength kite materials. Cables can be polypropylene, nylon, steel, and other high strength, light weight materials.

RMGs can be reversible motors, synchronous converters, and a variety of other electrical equipment.

A small tower may be needed as a safety measure to prevent cable from tangling with ground mounted equipment or potential obstructions.

1. A radio or line controlled kite or parachute capable of positioning at a high angle of attack to wind direction during power generation mode or low angle of attach during retrieval mode converting the kinetic energy of wind into useful work or other forms of energy the apparatus comprises at least one kite and at least one line in the form of cable, chain, wire, rope, or other means attached to ground mounted energy generation device such as a reverse motor/generator capable of generating electrical energy during kite high thrust power mode and retracting line during low thrust power retrieval mode.

2. Apparatus as in claim 1 wherein the thrust produced by the kite is converted directly to energy to drive line shafts, pumps, or other equipment located at ground level.

3. Apparatus as described in claim 1 in which line between kite and ground control contains at least one additional cable, rope, wire, chain or other means for controlling kite distance and position and relative to wind direction through transmission of electrical, hydraulic or mechanical means.
